(19) United States
(12) Patent Application Publication
(10) Pub. No.: US 2023/0404732 A1
(43) Pub. Date: Dec. 21, 2023

(54) APPARATUS, METHOD AND SYSTEM FOR CLEANING TEETH EXTRINSICALLY AND INTRINSICALLY

(71) Applicant: Kelli Prescott, Edmond, OK (US)

(72) Inventor: Kelli Prescott, Edmond, OK (US)

(21) Appl. No.: 18/209,721

(22) Filed: Jun. 14, 2023

Related U.S. Application Data
(60) Provisional application No. 63/352,513, filed on Jun. 15, 2022.

(51) Int. Cl. A61C 19/06

(52) U.S. Cl. CPC A61C 19/066

(57) ABSTRACT

A strip and method to extrinsically and intrinsically clean teeth wherein the strip is flexible and has been soaked in a disinfectant. In the related method the flexible, then nylon strip is soaked in a disinfectant solution. The resulting coated strip is thereafter applied to teeth so as to both extrinsically and intrinsically clean the teeth.

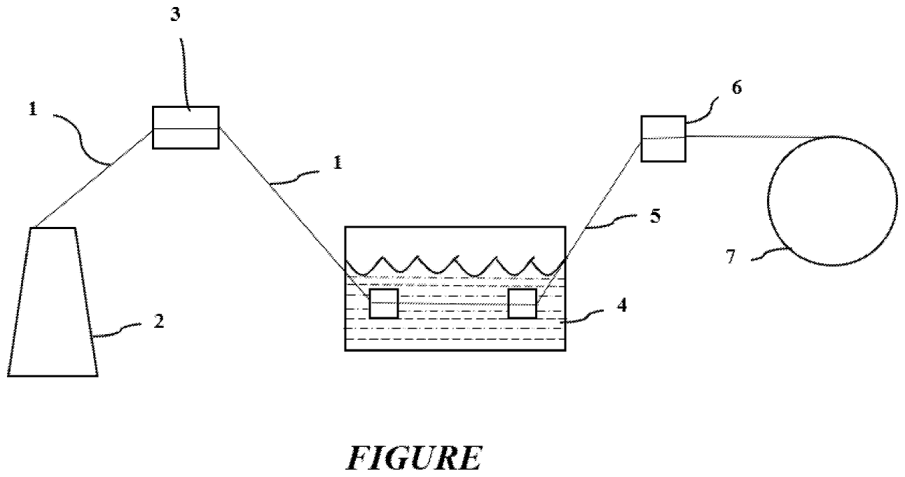

### CROSS REFERENCE TO RELATED APPLICATION

This application claims the benefit of U.S. Patent Application Ser. No. 63/352,513, filed Jun. 15, 2022; the entire disclosure of which is incorporated herein by reference in its entirety.

### BACKGROUND

Teeth are subject to both extrinsic and intrinsic staining. Extrinsic staining occurs when the outer layer of the tooth enamel is exposed to dark foods and drinks, smoking, and when plaque and tartar develop, clinging to the teeth and creating a dark interproximal area. Over the counter interproximal teeth cleaners include dental floss, tooth picks, pre-threaded flossers, interdental brushes, and powered air or water flossers. These are products known in the art to treat extrinsic stains and debris removal. Intrinsic staining occurs when the second, inner, layer of tooth structure is stained by dark foods and drinks. Teeth-staining foods and drinks change the color of the dentin on a molecular level. Whitening products applied by dental professionals or through at-home kits are used and known in the art to treat intrinsic stains. Also known in the art are interproximal strips, which are used by dental professionals to smooth and restore resin fillings, as well as periodontal hand and ultrasonic scalers for interproximal cleanings. These instruments, products, systems and methods are, however, not able to provide an extrinsic and intrinsic cleaning all the way in between teeth.

### SUMMARY

The claimed invention is a flexible, thin, nylon strip that has been soaked in hydrogen peroxide or other disinfectant for human use as well as a method and system of using the same to clean teeth both extrinsically and intrinsically.

For example, the method of using a cleaning strip comprises soaking a flexible, thin nylon strip in a disinfectant solution to thus produce a coated strip, and thereafter applying the coated strip to teeth so as to both extrinsically and intrinsically clean the teeth.

### BRIEF DESCRIPTION OF THE DRAWINGS

The drawing included with this application illustrates certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

The FIGURE is a schematic illustration of a hydrogen peroxide or another disinfectant being applied to a strip.

### DETAILED DESCRIPTION

The subject matter disclosed is capable of considerable modifications, alterations, combinations, and equivalents in form and function, as will occur to those skilled in the art with the benefit of this disclosure. Before discussing the presently disclosed inventive concepts in detail by way of exemplary description, drawings, experimentation, and results, it is to be understood that the inventive concepts disclosed herein are not limited in application to the details of construction and the arrangement of the compositions, formulations, steps, or components set forth in the following description or illustrated in the drawings, examples, experiments, and/or results. The presently disclosed inventive concepts are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting except where indicated as such.

All of the compositions, devices, systems, and/or methods disclosed herein can be made and executed without undue experimentation in light of the present disclosure. Although certain steps are described herein and illustrated in the FIGURE as occurring sequentially, some steps may occur simultaneously with each other or in an order that is not depicted. While the compositions, devices, systems, and/or methods of the presently disclosed inventive concepts have been described in terms of particular examples and embodiments, it will be apparent to those skilled in the art that variations may be applied to the compositions, devices, systems, and/or methods and in the steps or in the sequence of steps of the methods described herein without departing from the concept, spirit, and scope of the presently disclosed inventive concepts. All such similar substitutes and modifications apparent to those skilled in the art are deemed to be within the spirit, scope, and concept of the presently disclosed inventive concepts as defined by, but not limited to, the appended claims.

As utilized in accordance with the present disclosure, the following terms, unless otherwise indicated, shall be understood to have the following meanings: the use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements, or method steps.

Throughout this disclosure, the terms “about”, “approximate”, and variations thereof, are used to indicate that a value includes the inherent variation or error for the device, system, the method being employed to determine the value, or the variation that exists among the study subjects. For example, but not by way of limitation, when the terms “about” or “approximately” are utilized, the designated value may vary by +/− twelve percent, or +/− eleven percent, or +/− ten percent, or +/− nine percent, or +/− eight percent, or +/− seven percent, or +/− six percent, or +/− five percent, or +/− four percent, or +/− three percent, or +/− two percent, or +/− one percent, or +/− one-half percent. As used herein the symbol “+/−” indicates “plus or minus”.

The use of the term “at least one” will be understood to include one as well as any quantity more than one, including but not limited to, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, or more. The term “at least one” may extend up to 500 or 1000 or more, depending on the term to which it is attached; in addition, the quantities of 500/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition.

The term “or combinations thereof” as used herein refers to all permutations and combinations of the listed items preceding the term. For example, “A, B, C, or combinations thereof” is intended to include at least one of: A, B, C, AB, AC, BC, or ABC; and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

The claimed invention is a flexible, thin, nylon strip that has been soaked in hydrogen peroxide or other disinfectant for human use as well as a method and system of using the same to clean teeth both extrinsically and intrinsically.

One embodiment of the claimed invention is a flexible, thin, nylon strip that has been soaked in hydrogen peroxide and/or a method and system of soaking a flexible, thin, nylon strip in hydrogen peroxide and applying it to and in between teeth. As used herein “flexible” means cable of bending so as to conform to the surface of a tooth and to be positioned between teeth so as to abrasively clean teeth without breaking.

The dimensions of this product may vary but during application to and between the teeth the length will typically be about 60 mm to about 600 mm, and more typically about 150 mm to about 450 mm. While the length is recited during application, the strip can be provided in longer lengths (greater than 60 mm, 150 mm, 450 mm or even 600 mm) and then cut to the appropriate application length. A strip can be at least 2 mm, at least 3 mm, at least 5 mm, or at least 7 mm in breadth. Generally, the strip will be less than about 10 mm or less than about 8 mm in breadth. A strip will typically be at least 0.1 mm, at least 0.2 mm or at least 0.3 mm in thickness but should not be so thick as to prevent insertion between teeth; thus, for example, a strip will typically be less than 0.5 mm in thickness. This apparatus, system and/or method may be used as an interdental cleaner that removes both extrinsic and intrinsic staining. Extrinsically, it removes any plaque, developing tartar, and stain from dark foods and drinks. For example, the nylon strip physically removes the debris, thus creating a more vibrant and white interproximal area. Intrinsically, hydrogen peroxide removes any staining in the enamel and dentin tooth layers by breaking down intrinsic stains, thereby allowing the tooth to reflect light in a way that produces a whiter smile. Without proper extrinsic and intrinsic interproximal cleaning, it may be difficult to have a whiter smile, regardless of buccal or facial surface brightness.

As illustrated in the FIGURE, a nylon strip 1 can be unwound from a supply roll 2, passed through an eyelet or tensioner 3. Strip 1 can then be based into bath 4 containing hydrogen peroxide or another disinfectant to be applied to or coated on to the surface of strip 1. The now coated strip 5 passes through a second eyelet or tensioner 6 and then rewound onto take-up roll 7.

Generally, it is preferred to use the coated strip 5 soon after coating; thus, in embodiments coating will occur in smaller segments than would generally be done by the process of the FIGURE. For example, in use the nylon strip is first cut to the appropriate length. Then the strip is introduced into a bath of hydrogen peroxide, which in some applications may be present in a carbamide peroxide solution and in others is a solution of only hydrogen peroxide in water. Although, the strip may be soaked in the bath of hydrogen peroxide in advance of use, it is generally preferred that the soak be not so far in advance of application that the hydrogen peroxide will break down into water. Accordingly, the strip will generally be introduced into the bath about 1 min to 20 min prior to application to the teeth, and more typically, from about 2 min to about 10 min, before application to the teeth so as to sufficiently absorb the hydrogen peroxide and reduce the effect of hydrogen peroxide breakdown. The hydrogen peroxide should be present in concentration from about 3%, or from about 6% or from about 10%; the maximum concentration being about 40%, about 35%, or about 20%. If carbamide peroxide is used it will typically be in concentrations of from 10% or from 15% to about 40%, about 30% or about 20%.

After the strip has been in the bath for the appropriate amount of time, the strip is applied to the teeth so as to result in extrinsic and intrinsic cleaning. Generally, such cleaning will involve moving the strip along the surface of the teeth, including between teeth, so as to extrinsically clean the teeth while simultaneously applying the hydrogen peroxide to the teeth resulting in intrinsic cleaning. Accordingly, the use of the strip provides cleaning not only on the exposed surface of the teeth but provides intrinsic and extrinsic cleaning all the way between the teeth, or in other words, provides intrinsic and extrinsic cleaning by application to all exterior tooth surfaces.

There are many benefits of the claimed invention(s) over what is known in the prior art. To the inventor's knowledge, there is no single instrument or method that simultaneously cleans extrinsic and intrinsic teeth stains. To the inventor's knowledge, there is no product known or available which is gentle on enamel surfaces of teeth, yet abrasive enough to remove debris. Furthermore, most interproximal dental cleaners only clean extrinsically. Toothbrushes and toothpaste work in tandem to clean both extrinsically and intrinsically, and floss is well-known to clean teeth extrinsically. However, these products lack the efficacy of a disinfectant and the abrasiveness of the strip of the present invention(s). The claimed invention(s) solves these problems and is also inexpensive to produce and use.

Other embodiments of the present invention will be apparent to one skilled in the art. As such, the foregoing description merely enables and describes the general uses and methods of the present invention.

What is claimed is:

1. A strip comprising a nylon, wherein the strip is flexible and has been soaked in a disinfectant.

2. The strip of claim 1, wherein in the disinfectant is hydrogen peroxide.

3. The strip of claim 2, wherein the breath of the strip is between 2 mm and 10 mm.

4. The strip of claim 3, wherein the thickness of the strip is at least 0.1 mm but less than 0.5 mm so as not to prevent insertion between teeth.

5. A method of using a cleaning strip, the method comprising:
soaking a flexible, thin nylon strip in a disinfectant solution to thus produce a coated strip; and
thereafter applying the coated strip to teeth so as to both extrinsically and intrinsically clean the teeth.

6. The method of claim 5, wherein the disinfectant solution is a hydrogen peroxide solution.

7. The method of claim 6, wherein the hydrogen solution is produced from the group consisting of carbamide peroxide and water, hydrogen peroxide and water, and combinations thereof.

8. The method of claim 7, wherein prior to the step of soaking the nylon strip, the method comprises cutting the nylon strip into an appropriate length of from 60 mm to 600 mm.

9. The method of claim 8, wherein the step of applying the coated strip to teeth occurs minutes or less after the step of soaking the nylon strip.

10. The method of claim 9, wherein the hydrogen peroxide is present in the disinfectant solution in an amount from about 3% to about 40%.

11. The method of claim 9, wherein the hydrogen peroxide is present in the disinfectant solution in an amount from about 6% to about 35%.

12. The method of claim 11, wherein the hydrogen peroxide is present in the disinfectant solution in an amount from about 10% to about 20%.

13. The method of claim 12, wherein the step of applying the coated strip to teeth comprises moving the strip along the surface of the teeth, including between the teeth, so as to extrinsically clean the teeth while simultaneously applying the hydrogen peroxide to the teeth resulting in intrinsic cleaning.

14. The method of claim 13, wherein the step of applying the coated strip to teeth occurs from 1 minutes to 20 minutes after the step of soaking the nylon strip.

15. The method of claim 14, wherein the breath of the strip is between 2 mm and 10 mm.

16. The method of claim 15, wherein the thickness of the strip is at least 0.1 mm but less than 0.5 mm so as not to prevent insertion between teeth.
